(19) United States
(12) Patent Application Publication
(10) Pub. No.: US 2010/0124596 A1
(43) Pub. Date: May 20, 2010

(54) Insulated cover and method for cooking pizza and similar food items on a home gas or charcoal grill

(75) Inventor: Randall Warren Nelson, Pompano Beach, FL (US)

Correspondence Address: Randall W. Nelson, 2535 SE 11th Street, Pompano Beach, FL, 33062, US

(73) Assignee: Randall Warren Nelson, Pompano Beach, FL (US)

(21) Appl. No.: 12/590,812

(22) Filed: Nov. 16, 2009

Related U.S. Application Data
(60) Provisional application No. 61/199,464, filed on Nov. 17, 2008.

(51) Int. Cl. A47J 37/07; A47J 37/00; A47J 39/00; A23L 1/01

(52) U.S. Cl. 426/523; 99/447; 126/25 R; 99/467

(57) ABSTRACT

An insulated cover and method that makes it possible to create a thermal environment on a home gas or charcoal grill similar to that produced by a wood fired brick oven or commercial pizza oven. The cover is made from a high temperature resistant, thermal insulation material that is encapsulated (sandwiched) between thin metal sheet or metal foil skins. The insulated cover covers both a food support surface that has been placed on the grill's grate directly over the grill's heat source and the remainder of grills grate area that is suspended directly above the grills heat source that is not already covered by the food support surface. The food items are cooked from below by the thermal energy stored in the food support surface, and from above by the thermal energy contained within the low volume zone created by the insulated cover resulting in uniform, fast, even and energy efficient cooking of food items like pizza.

### CROSS-REFERENCE TO RELATED APPLICATIONS

The present application claims filing date priority under 35 USC 119 based on U.S. provisional application Ser. No. 61/199,464, filed Nov. 17, 2008. The entire disclosure of U.S. provisional application Ser. No. 61/199,464, is incorporated herein by reference.

### BACKGROUND OF THE INVENTION

The present invention relates to accessories for enhanced cooking and with particular regards to a home gas or charcoal grill. More particularly, the present invention relates to a portable, thermally insulated, cover and method configured to cook food items, such as pizza, on a home gas or charcoal grill by creating a thermal environment similar to that of a wood fired brick oven or commercial pizza oven.

Cooking of foods on a home gas or charcoal grill has become an extremely popular method of food preparation. The typical grill includes a heat source, in the form of a gas burner or charcoal, and a grate suspended above the heat source. The grate serves as means to support the food being cooked over the heat source. In order to contain the heat, most modern barbecue grills also include a hinged lid or cover which provides a substantial enclosed space above the grill. The food is cooked by the heat from the heat source and from the hot air within the enclosed grill.

Pizza is a popular food item both in the United States and in many other parts of the world. Nutritionally, pizza has many advantages since its taste is widely popular and, in a single food item, it can provide many nutrients. Pizza is often made in commercial establishments with dedicated ovens for cooking this type of food. The use of wood fired brick ovens in commercial establishments is becoming increasingly popular. Pizza may also be cooked in home ovens or gas or charcoal grills but home ovens and grills typically can not achieve the same thermal environment of a wood fired brick oven or commercial pizza oven.

U.S. Pat. No. 6,640,695 discloses a device to be placed upon an enclosed grill for cooking pizzas. The device includes a tile supported by a structure with legs. The legs sit upon the grill surface and keep the tile away from the surface. The heat source heats the tile and the surrounding air within the enclosed grill. The pizza is placed upon the tile and is cooked by the tile and the surrounding air. This device relies on a lid of an enclosed grill to contain the heat. Grill lids are typically not insulated and the temperatures achieved inside the volume created by closing the grill lid are not as high as those in a smaller volume created from using the insulated cover that is the present invention. Even if the grill lid is insulated, heating the larger volume is much less efficient than heating the smaller volume of the insulated cover.

U.S. Pat. No. 3,035,568 discloses a portable baking device which can be used with an outdoor charcoal fired grill. The device includes a lower plate with a skirt and a domed lid. The lower plate allows heat from a heat source to enter the device and to create a uniform temperature within the domed lid. However, the device relies on a non-insulated lid, and it is limited to capturing the thermal energy from the heat source that is immediately below the food support surface.

U.S. Pat. No. 6,187,359 has a deep pan structure to be placed directly on the grill of a barbecue. The device also has vents or holes in the bottom of the pan to allow hot gases and smoke to penetrate. A pizza is placed upon a second pan placed on top of the extending sides of the device. It does not create a low volume, enclosed zone for creating a uniform temperature around the pizza. It relies upon the lid of a closed grill to contain the heat.

U.S. Pat. No. 7,219,663 has a food support member having a plurality of openings formed there through, and a heat shield for placement below and spaced away from the food support member. Although not included in the CLAIMS for this patent an optional, domed cover is referred to for use with the apparatus. The optional, domed cover is not insulated and it is not designed to cover the grill's grate area that is suspended directly above the grills heat source that is not already covered by the food support surface.

U.S. Pat. Application No. 20,060,102,167 is for an oven that has a bottom that is used as the food support surface that is enclosed by sides and a top. The area enclosed by the oven is not insulated. The oven only utilizes the thermal energy that is directly below the area covered by the oven's bottom and which is transmitted through the bottom. The insulated cover of the present invention is intentionally open on the bottom side to allow for accumulation of thermal energy coming both directly from the heat source that is not covered by a food support surface, as well as from the thermal energy transmitted through the food support surface.

### BRIEF SUMMARY OF THE INVENTION

The present invention provides an improved portable apparatus and method that creates a thermal environment similar to that of a wood fired brick oven or commercial pizza oven to quickly and efficiently cook pizza and similar food items. The inventive apparatus is a one piece, thermally insulated cover.

In use the insulated cover is positioned to cover both a) a food support surface that is supported by the grill's grate area that is directly over the grill's heat source, and b) the remainder of the grill's grate area that is suspended directly above the grills heat source and not already covered by the food support surface, to create an insulated, relatively small volume zone that quickly and efficiently accumulates thermal energy originating from the heat source to both pre-heat the food support surface and cook the desired food items.

The invention is unique from prior art in that it combines the use of thermal insulation encapsulated in thin metal sheet or metal foil, a reflective, interior surface, and a design specifically sized to cover both a) a food support surface that is supported by the grill's grate area that is directly over the grill's heat source, and b) that portion of a grills grate area that is suspended directly over the grills heat source and not already covered by the food support surface.

Even in cases where the heat source of certain grills is sufficiently powerful to create temperatures inside the closed grill lid comparable to those in a wood fired brick oven there is an efficiency advantage to using the present invention as far less fuel and time will be consumed to preheat the food support surface and cook the food due to heating a relatively small volume compared to much larger volume formed by closing the grill's lid.

Due to the present inventions use of a small volume, insulated space, a reflective interior surface and design that is sized to capture thermal energy from the entire heat source of a grill it is more energy efficient than previous art that attempts to produce similar thermal conditions without the combination of these features.

### BRIEF DESCRIPTION OF THE SEVERAL VIEWS OF THE DRAWING

FIG. 1 is a perspective view of an insulated cover according to an embodiment of the present invention.

FIG. 2 is a perspective view of an insulated cover according to an embodiment of the present invention shown in use on an outdoor grill.

FIG. 3 is a front view of an insulated cover according to an embodiment of the present invention shown in use on an outdoor grill, showing the encapsulated thermal insulation construction of the cover and the relative position of the cover to the food support surface and that portion of the grill's grate area not covered by the food support surface which is directly over the grill's heat source.

FIG. 4 is a cross sectional view of the material used to make the insulated cover illustrating thermal insulation encapsulated between thin sheet metal or metal foil skins.

### DETAILED DESCRIPTION OF THE INVENTION

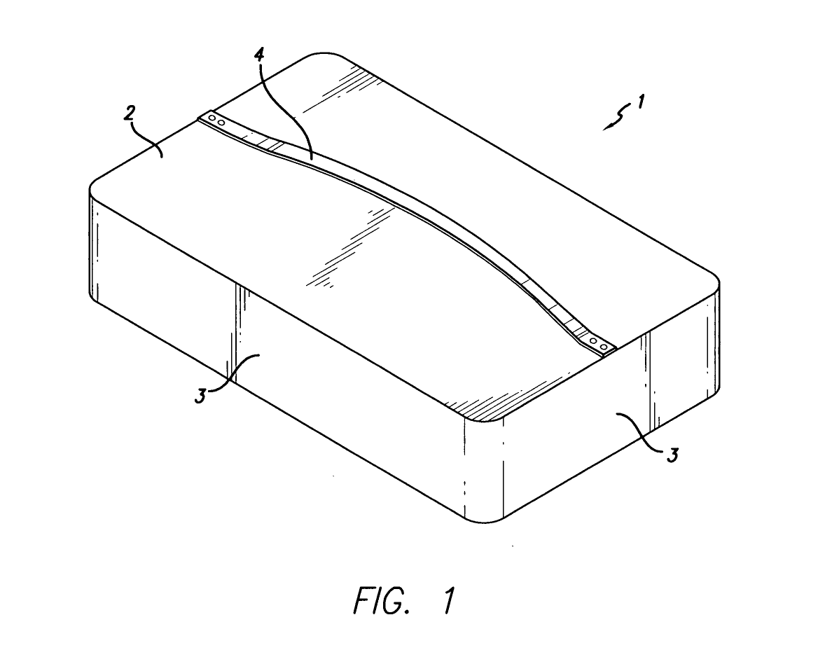

Referring to the figures, and especially to FIGS. 1-3 an insulated cover and method according to an embodiment of the present invention will now be described. The insulated cover 1 is well suited for use on a home gas or charcoal grill 9 to create a thermal environment similar to that produced by wood fired brick oven or commercial pizza oven.

As illustrated in FIGS. 1-3 the insulated cover 1 that is the present invention is a one piece cover having a top 2 sides 3 and a handle 4 that is attached to the top 2. According to the embodiment of the invention as illustrated in FIGS. 1-3 the insulated cover 1 is substantially rectangular in shape having four sides 3 that are perpendicular to the top 2. The sides 3 are sized to position the top 1 approximately three inches above the grills grate 5.

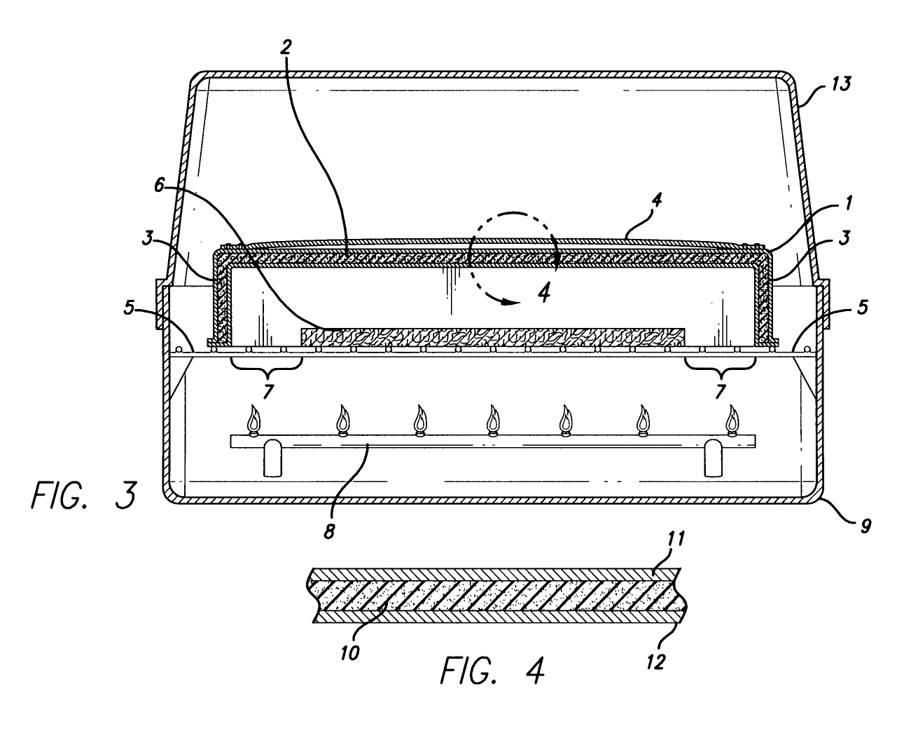

FIG. 3 shows the insulated cover 1 supported on a grill's grate 5 and covering both a food support surface 6, and that area 7 of the grill's grate 5 that is suspended directly above the grills heat source 8 that is not already covered by the food support surface 6.

FIG. 4 is a cross sectional view taken from FIG. 3 of the material used to make the insulated cover illustrating thermal insulation 10 encapsulated between a thin sheet metal or metal foil outer skin 11, and a thin sheet metal or metal foil inner skin 12. The metal material used for the concave surface of the inner skin 12 will have a reflective surface to reflect thermal energy down towards the food support surface 6. Skins are typically press formed in a process similar to that used to form foil baking pans sold in grocery stores. The insulation 10 is placed between the formed outer and inner skins and the edges of the skins can be joined together using welding or crimping techniques, or a high temperature cement.

The handle 4 is attached to the top 2 using rivets or a high temperature thermal cement.

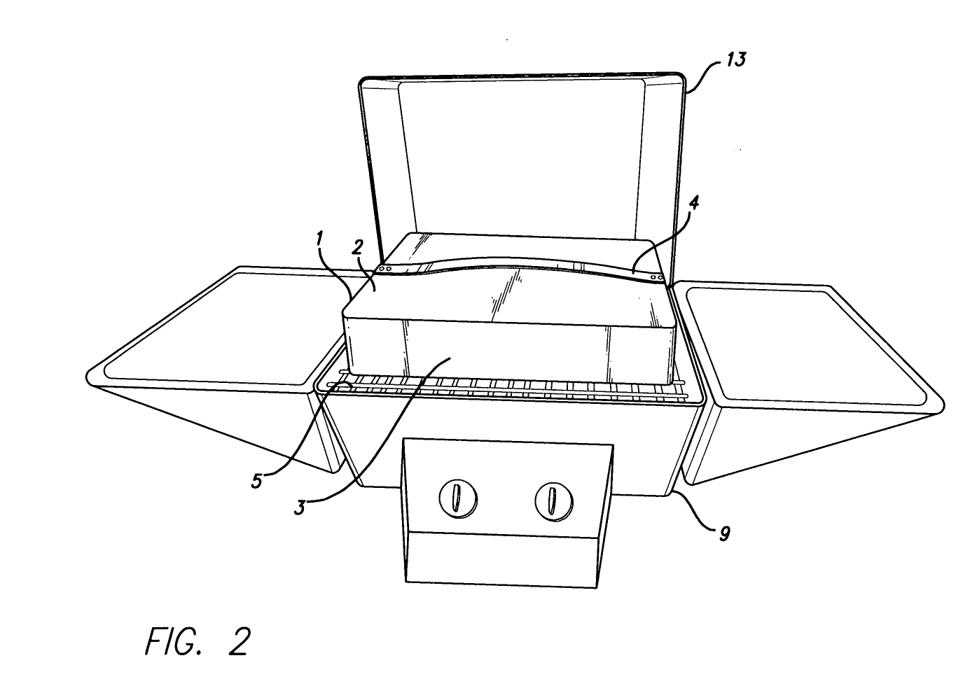

In use the insulated cover 1 is placed on a grill's grate 5 as shown in FIGS. 2-3. The method does not require that the grill's lid 13 be in the closed position.

The method requires preheating of the food support surface 6 by placing the insulated cover 1 to cover the food support surface 6 and the remainder of the grill's lower grate area 7 that is suspended directly over the grills heat source 8 that is not already covered by the food support surface 6 as shown in FIG. 3. After the food support surface 6 is preheated the insulated cover 1 is removed from the grill's grate 5. The food items to be cooked are then placed on the preheated food support surface 6 using a pizza peel or other suitable food handling device and the insulated cover 1 is placed back on the grill's grate 5 in the same position used to preheat the food support surface 6 to cook the food items.

Other embodiments of the invention will vary in both size and shape to accommodate different grill sizes and shapes.

Having described at least one embodiment of the invention, various modifications, adaptations, additions and extensions will be readily apparent to those of skill in the art. Such modifications, adaptations, additions and extensions are considered to be within the scope of the invention, which is not limited except as to the claims hereto.

What is claimed as my invention is:

1. An insulated cover for cooking pizza and similar food over a home gas or charcoal grill comprising: a top, sides, one open side and a handle that is affixed to the top wherein the insulated cover is sized to cover both a) a food support surface that is supported by the grill's grate area that is directly over the grill's heat source, and b) the remainder of the grill's grate area that is suspended directly above the grills heat source and not already covered by the food support surface.

2. The insulated cover according to claim 1 wherein the cover is made from a high temperature resistant, thermal insulation material that is encapsulated between thin, flame resistant sheet metal or metal foil skins.

3. The insulated cover according to claim 1 wherein the sides of the cover are sized to position the top of the cover approximately 3″ above a food support surface.

4. The insulated cover according to claim 1 wherein the cover forms a relatively low volume, enclosed area above the grill's heat source when placed open side down on the grill grate.

5. The insulated cover according to claim 1 wherein the cover is rectangular.

6. The insulated cover according to claim 1 wherein the cover is square.

7. The insulated cover according to claim 1 wherein the cover is oval.

8. The insulated cover according to claim 1 wherein the cover is round.

9. The insulated cover according to claim 1 wherein the heat source is a home gas or charcoal grill.

10. The insulated cover according to claim 1 for converting a home gas or charcoal grill into an oven for baking pizza and similar food items that is capable of creating a thermal environment with temperatures comparable to those created in a wood fired brick oven.

110. The insulated cover according to claim 1 that is sized to adapt to the physical characteristics of specific grill models and designs.

12. The insulated cover according to claim 1 wherein the cover is optionally sized to cover either single or multiple heating zones on grills having more that one independent heating zone.

13. The insulated cover according to claim 2 wherein the concave surface of the interior skin has a reflective finish to reflect thermal energy down towards the food support surface.

14. A method of baking food on a home gas or charcoal grill comprising the steps of:
a) providing a thermally insulated, flame resistant, heat retaining, one piece cover that is sized to be placed over both; a food support surface that is supported by an area of the grill's grate that is directly over the grill's heat source, as well as that area of the grill's grate that is suspended directly above the grill's heat source that is not already covered by the food support surface to create a low volume zone of uniform, high temperature,
b) placing a food support surface consisting of a commercially available baking stone or pizza stone on that area of the grill's grate that is suspended directly over the grills heat source,
c) placing the insulated cover over both the food support surface, and the remainder of the grill's grate area that is suspended directly above the grills heat source but not already covered by the food support surface, to pre-heat the food support surface,
d) pre-heating the food support surface,
e) removing the insulated cover from the grill's grate,
f) placing food on the pre-heated food support surface using a pizza peel or other food handling device,
g) placing the insulated cover back on the grill's grate over the food that is being supported by the food support surface, and
h) baking the food item beneath the insulated cover on the grill.

15. A method according to claim 14 wherein the thermal insulation in the cover prevents any substantial loss of the thermal energy coming from the grills heat source.

16. A method according to claim 14 wherein the reflective interior, concave surface of the thermally insulated cover reflects thermal energy down towards the food support surface.

17. A method according to claim 14 that is energy efficient due to the use of thermal insulation to prevent any substantial loss of thermal energy coming from the grill's heat source.

18. A method according to claim 14 using an insulated cover on a home gas or charcoal grill for obtaining high quality baked pizza and other food items similar to that baked in a wood fired brick oven or commercial pizza oven.
